(19) United States
(12) Patent Application Publication
(10) Pub. No.: US 2026/0138528 A1
(43) Pub. Date: May 21, 2026

(54) NOTIFICATION CONTROL DEVICE, NOTIFICATION CONTROL METHOD, AND STORAGE MEDIUM

(71) Applicant: HONDA MOTOR CO., LTD., Minato-ku (JP)

(72) Inventors: Hirotaka Katayama, Tokyo (JP); Yuichi Masukake, Wako-shi (JP); Kazuma Hamada, Tokyo (JP)

(21) Appl. No.: 19/379,952

(22) Filed: Nov. 5, 2025

(30) Foreign Application Priority Data
Nov. 21, 2024 (JP) 2024-203141

(51) Int. Cl. B60Q 9/00; G07C 5/02

(52) U.S. Cl. CPC B60Q 9/00; G07C 5/02

(57) ABSTRACT

A notification control device includes a recognizer configured to recognize a monitoring direction of a driver of a mobile object and a state of the driver, a first determiner configured to determine whether the monitoring direction of the driver is appropriate based on a result of recognition, a second determiner configured to determine whether the driver is taking a behavior other than driving of the mobile object based on the result of recognition, and a notification controller configured to control notification to the driver based on a result of determination. The notification controller curbs the notification when the first determiner determines that the monitoring direction of the driver is appropriate, the second determiner determines that the driver is taking a behavior other than driving, and a degree of influence of the behavior other than driving on surroundings monitoring is less than a first threshold value.

### CROSS-REFERENCE TO RELATED APPLICATION

Priority is claimed on Japanese Patent Application No. 2024-203141, filed Nov. 21, 2024, the content of which is incorporated herein by reference.

### BACKGROUND

### Field of the Invention

The present invention relates to a notification control device, a notification control method, and a storage medium.

### Description of Related Art

Recently, countermeasures for providing access to a sustainable transportation system in which vulnerable persons out of traffic participants are also considered have been actively studied. In order to realize such countermeasures, focus has been concentrated on research and development for further improving safety or convenience of traffic through research and development on preventive safety technology. In this regard, a technique of recognizing a gaze or a face direction of a driver using an image captured by a driver camera and supporting the driver when it is determined as a result of recognition that the driver is performing sideways-glance driving is known in the related art (for example, Japanese Unexamined Patent Application, First Publication No. 2019-91281).

### SUMMARY

In such preventive safety technology according to the related art, a technique of considering that the driver does not pay attention to driving and performing notification when the driver is taking a behavior other than driving independently from a sideways glance is also known. However, since the behavior other than driving includes various types, notification information may be output even in a state in which the driver pays attention to driving. Accordingly, there is a problem in that a state of a driver is not likely to be appropriately notified.

In order to solve the aforementioned problem, an objective of the present invention is to provide a notification control device, a notification control method, and a storage medium that can perform more appropriate notification according to a driver's state. Another objective thereof is to contribute to advancement of a sustainable transportation system.

A notification control device, a notification control method, and a storage medium according to the present invention employ the following configurations.
(1) According to an aspect of the present invention, there is provided a notification control device including a recognizer configured to recognize a monitoring direction of a driver of a mobile object and a state of the driver, a first determiner configured to determine whether the monitoring direction of the driver is appropriate on the basis of a result of recognition from the recognizer, a second determiner configured to determine whether the driver is taking a behavior other than driving of the mobile object on the basis of the result of recognition, and a notification controller configured to control notification to the driver on the basis of a result of determination from the first determiner and a result of determination from the second determiner, wherein the notification controller curbs the notification when the first determiner determines that the monitoring direction of the driver is appropriate, the second determiner determines that the driver is taking a behavior other than driving, and a degree of influence of the behavior other than driving on surroundings monitoring is less than a first threshold value.
(2) In the aspect of (1), the behavior of which the degree of influence on the surroundings monitoring is less than the first threshold value includes a behavior which is predicted to end within a predetermined time.
(3) In the aspect of (1), the behavior of which the degree of influence on the surroundings monitoring is less than the first threshold value includes a behavior which is predicted to be taken by the driver with one hand.
(4) In the aspect of (1), the behavior of which the degree of influence on the surroundings monitoring is less than the first threshold value includes a behavior in which the driver puts on or takes off a wearing article.
(5) In the aspect of (1), the behavior of which the degree of influence on the surroundings monitoring is less than the first threshold value includes a behavior of the driver associated with foods.
(6) In the aspect of (1), the notification controller performs the notification regardless of the result of determination from the second determiner when the first determiner determines that the monitoring direction of the driver is not appropriate.
(7) In the aspect of (1), the recognizer recognizes an amount of change in monitoring direction of the driver in a predetermined time or a changing speed, and the notification controller performs notification regardless of the result of determination from the first determiner and the result of determination from the second determiner when the amount of change or the changing speed is equal to or greater than a second threshold value.
(8) According to another aspect of the present invention, there is provided a notification control method that is performed by a computer, the notification control method including recognizing a monitoring direction of a driver of a mobile object and a state of the driver, determining whether the monitoring direction of the driver is appropriate on the basis of a result of recognition, determining whether the driver is taking a behavior other than driving of the mobile object on the basis of the result of recognition, controlling notification to the driver on the basis of results of determination, and curbing the notification when it is determined that the monitoring direction of the driver is appropriate, it is determined that the driver is taking a behavior other than driving, and a degree of influence of the behavior other than driving on surroundings monitoring is less than a first threshold value.
(9) According to another aspect of the present invention, there is provided a non-transitory computer-readable storage medium storing a program, the program causing a computer to perform recognizing a monitoring direction of a driver of a mobile object and a state of the driver, determining whether the monitoring direction of the driver is appropriate on the basis of a result of recognition, determining whether the driver is taking a behavior other than driving of the mobile object on the basis of the result of recognition, controlling notification to the driver on the basis of results of determination, and curbing the notification when it is determined that the monitoring direction of the driver is appropriate, it is determined that the driver is taking a behavior other than driving, and a degree of influence of the behavior other than driving on surroundings monitoring is less than a first threshold value.

According to the aspects of (1) to (9), it is possible to perform more appropriate notification according to a driver's state.

### BRIEF DESCRIPTION OF THE DRAWINGS

FIG. 1 is a diagram illustrating a configuration of a vehicle system including a notification control device according to an embodiment.

FIG. 2 is a diagram illustrating an example of data details of driver state data.

FIG. 3 is a diagram illustrating a relationship between a monitoring direction of a driver and a monitoring target area.

FIG. 4 is a diagram illustrating an example of a situation in which notification of second notification information is curbed.

FIG. 5 is a diagram illustrating an example of a situation in which notification of second notification information is not curbed.

FIG. 6 is a diagram illustrating a change in monitoring direction of a driver.

FIG. 7 is a flowchart illustrating an example of a process flow that is performed by a driving support device according to the embodiment.

### DESCRIPTION OF EMBODIMENTS

Hereinafter, a notification control device, a notification control method, and a storage medium according to an embodiment of the present invention will be described with reference to the accompanying drawings. In the following description, it is assumed that the notification control device is applied to a mobile object. It is assumed that a vehicle is used as an example of a mobile object. Examples of the mobile object may include a ship which can move on the ground (on a road) such as a hovercraft, a flying object which can travel on a road, a standing riding vehicle including a power unit, and micromobility such as an electric scooter in addition to a vehicle.

### Entire Configuration

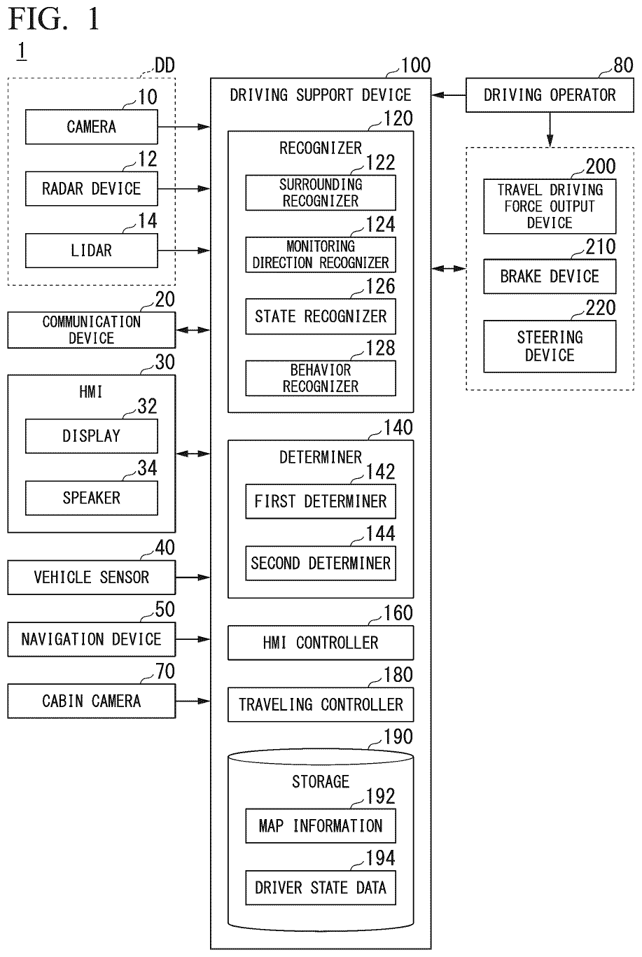

FIG. 1 is a diagram illustrating a configuration of a vehicle system 1 including a notification control device according to an embodiment. A vehicle in which the vehicle system 1 is mounted (hereinafter referred to as a vehicle M) is, for example, a vehicle with two wheels, three wheels, or four wheels or micromobility, and a drive source thereof is an internal combustion engine such as a diesel engine or a gasoline engine, an electric motor, or a combination thereof. The electric motor operates using electric power generated by a power generator connected to the internal combustion engine or using electric power discharged from a battery (storage battery) such as a secondary battery or a fuel cell.

The vehicle system 1 includes, for example, a camera 10, a radar device 12, a Light Detection and Ranging (LIDAR) device 14, a communication device 20, a human-machine interface (HMI) 30, a vehicle sensor 40, a navigation device 50, a cabin camera 70, a driving operator 80, a driving support device 100, a travel driving force output device 200, a brake device 210, and a steering device 220. These devices or instruments are connected to each other via a multiplex communication line such as a controller area network (CAN) communication line, a serial communication line, a radio communication network, or the like. The configuration illustrated in FIG. 1 is only an example, and a part of the configuration may be omitted or another configuration may be added thereto. The camera 10, the radar device 12, and the LIDAR device 14 constitute an example of a “detection device DD.” The HMI 30 is an example of a “notifier.” The HMI 30 and the driving support device 100 constitute an example of a “notification control device.”

The camera 10 is, for example, a digital camera using a solid-state imaging device such as a charge coupled device (CCD) or a complementary metal oxide semiconductor (CMOS) device. The camera 10 is attached to an arbitrary position on the vehicle M in which the vehicle system 1 is mounted. When a forward view is imaged, the camera 10 is attached to an upper part of a front windshield, a rear surface of a rearview mirror, a front head of a vehicle body, or the like. When a rearward view is imaged, the camera 10 is attached to an upper part of a rear windshield, a back door, or the like. When a side view is imaged, the camera 10 is attached to a door mirror on the right and left sides or the like. The camera 10 images the surroundings of the vehicle M, for example, periodically and repeatedly. The camera 10 may be a stereo camera.

The radar device 12 radiates radio waves (radiated waves) such as millimeter waves to the surroundings of the vehicle M, detects radio waves (reflected waves) reflected by a nearby object, and detects at least a position (a distance and a direction) of the object. The radar device 12 is attached to an arbitrary position on the vehicle M. The radar device 12 may detect a position and a speed of an object using a frequency modulated continuous wave (FM-CW) method.

The LIDAR device 14 radiates light to the surroundings of the vehicle M and measures scattered light. The LIDAR device 14 detects a distance to an object on the basis of a time from radiation of light to reception of light. The radiated light is, for example, a pulse-like laser beam. The LIDAR device 14 is attached to an arbitrary position on the vehicle M.

The communication device 20 communicates with other vehicles near the vehicle M, a terminal device of a user using the vehicle M, or various server devices, for example, using a network such as a cellular network, a Wi-Fi network, Bluetooth (registered trademark), or dedicated short range communication (DSRC), a local area network (LAN), a wide area network (WAN) or the Internet.

The HMI 30 outputs various types of information to an occupant (who includes a driver) of the vehicle M and receives an input operation from the occupant. The HMI 30 includes, for example, a display 32 and a speaker 34. The display 32 is, for example, a liquid crystal display (LCD) device or an organic electroluminescence (EL) display device. The display 32 displays various images (including a video) according to the embodiment. The display 32 may be configured as a touch panel which is a unified body with an input. The speaker 34 outputs predetermined sound (for example, an alarm sound or a message voice). The HMI 30 may include a microphone, buzzers, a touch panel, switches, and keys. The switches may include a switch for performing or ending predetermined driving control or the like which can be performed by a traveling controller which will be described later and a switch for allowing a system (the vehicle system 1) side to approve (permit) or reject recommendation (proposal) of driving control. The switches may include a switch (a turn signal switch) for performing a direction indication operation.

The vehicle sensor 40 includes a vehicle speed sensor that detects a speed of the vehicle M, an acceleration sensor that detects acceleration, and a yaw rate sensor that detects a yaw rate (for example, an angular velocity around a vertical axis passing through the center of gravity of the vehicle M). The vehicle sensor 40 may include a lateral acceleration sensor (a lateral G sensor) that detects a lateral acceleration (a lateral G) of the vehicle M, a rudder angle sensor that detects a rudder angle of the vehicle M (which may be an angle of turning wheels or a steering angle of a steering wheel), a rudder angular velocity sensor that detects a rudder angular velocity, or a direction sensor that detects a direction of the vehicle M.

The vehicle sensor 40 may include a position sensor that detects a position of the vehicle M. The position sensor is, for example, a sensor that acquires position information (longitude and latitude information) from a global positioning system (GPS) device. The position sensor may be a sensor that acquires position information using a global navigation satellite system (GNSS) receiver of the navigation device 50. The vehicle sensor 40 may derive the speed of the vehicle M from a difference in position information in a predetermined time (that is, a distance) in the position sensor. Results detected by the vehicle sensor 40 are output to the driving support device 100.

The navigation device 50 includes, for example, a GNSS receiver, a navigation HMI, and a route determiner. The navigation device 50 stores map information in a storage device such as a hard disk drive (HDD) or a flash memory or acquires map information 192 stored in a storage 190 which will be described later. The GNSS receiver identifies the position of the vehicle M on the basis of signals received from GNSS satellites. The position of the vehicle M may be identified or corrected by an inertial navigation system (INS) using the output of the vehicle sensor 40. The navigation HMI includes a display device, a speaker, a touch panel, and keys. The GNSS receiver may be provided in the vehicle sensor 40. The navigation HMI may be partially or wholly shared by the HMI 30. For example, the route determiner determines a route (hereinafter referred to as a route on a map) from the position of the vehicle M identified by the GNSS receiver (or an input arbitrary position) to a destination input by an occupant using the navigation HMI, for example, with reference to the map information 192. The navigation device 50 performs route guidance using the navigation HMI on the basis of the determined route on a map. The navigation device 50 may transmit a current position and a destination to a navigation server via the communication device 20 and acquire a route which is equivalent to the route on a map from the navigation server.

Here, the map information 192 is, for example, information in which a road shape is expressed by links indicating a road (an example of a traveling lane) and nodes connected by the links. The map information 192 may include point of interest (POI) information. The map information 192 includes, for example, the number of lanes (the number of traveling lanes), a type or shape of road marking lines, information of a lane center, or information of road boundaries. The map information 192 may include information indicating whether a road boundary is a boundary (a physical boundary) including a structure which a vehicle cannot pass through (which includes crossing or contacting). A physical boundary is, for example, a guardrail, a curbstone, a median strip, or a fence. The map information 192 may include road shape information, traffic regulation information, address information (addresses and postal codes), facility information, parking lot information, and phone number information. The road shape information is, for example, information on a curvature (which may be a radius of curvature), a width, a surface gradient, a branching or merging point, a crossing, or a T-road of a road, The map information 192 may be updated from time to time by causing the communication device 20 to communicate with an external device.

The cabin camera 70 is, for example, a digital camera using a solid-state imaging device such as a CCD or a CMOS device. The cabin camera 70 is attached to an arbitrary position on the vehicle M in a place and a direction in which the head of a driver sitting on a driver's seat of the vehicle M can be imaged from the front. For example, the cabin camera 70 is attached to the vicinity of (for example, an upper part or a lower part) of a display device which is provided at the center of an instrument panel of the vehicle M. The cabin camera 70 may image the cabin in an area including an occupant (passenger) sitting on a passenger's seat of the vehicle M in addition to the driver. The cabin camera 70 may image the cabin by emitting infrared light to the cabin. The cabin camera 70 images the cabin periodically and repeatedly.

The driving operator 80 includes, for example, a steering wheel, an accelerator pedal, and a brake pedal. The driving operator 80 may include a shift lever, a deformed steering wheel, a joystick, or other operators. For example, an operation detector that detects an amount of operation of a corresponding operator or whether an operation has been performed thereon by the driver is attached to the corresponding operator of the driving operator 80. The operation detector detects, for example, a steering angle or a steering torque (for example, an amount of steering (a steering input torque) based on the driver's driving operation) of the steering wheel, a rate of change in steering torque, and an amount of depression of the accelerator pedal or the brake pedal. Then, the operation detector outputs the results of detection to the driving support device 100 or some or all of the travel driving force output device 200, the brake device 210, and the steering device 220. The driving operator 80 may include a direction indicator operator (a turn signal lever or a turn signal switch). When the direction indicator operator is operated, a turn signal (the direction indicator) of the vehicle M correlated with details of the operation blinks, and the operation details (for example, which include a result of detection indicating that the operator is operated by the driver) are output to the driving support device 100.

The driving support device 100 performs various types of control for supporting a driver's driving of the vehicle M. The driving support device 100 includes, for example, a recognizer 120, a determiner 140, an HMI controller 160, a traveling controller 180, and a storage 190. The recognizer 120, the determiner 140, the HMI controller 160, and the traveling controller 180 are realized, for example, by causing a hardware processor such as a central processing unit (CPU) to execute a program (software). Some or all of these constituents may be realized by hardware (a circuit part including circuitry) such as a large scale integration (LSI) circuit, an application-specific integrated circuit (ASIC), or a field-programmable gate array (FPGA), a graphics processing unit (GPU), or a system on chip (SOC) or may be cooperatively realized by software and hardware. The program may be stored in a storage device (a storage device including a non-transitory storage medium) such as an HDD or a flash memory of the driving support device 100 in advance, or may be stored in a removable storage medium such as a DVD, a CD-ROM, or a memory card and installed in the storage device of the driving support device 100 by setting the storage medium (a non-transitory storage medium) into a drive device, a card slot, or the like. The traveling controller 180 is an example of an “movement controller.” The HMI controller 160 is an example of a “notification controller.”

The storage 190 may be realized by the aforementioned various storage devices, an electrically erasable programmable read only memory (EEPROM), a read only memory (ROM), a random access memory (RAM), or the like. For example, the map information 192, driver state data 194, and various types of information and programs in the embodiment are stored in the storage 190. Various types of setting information used in processes according to the present embodiment may be stored in the storage 190.

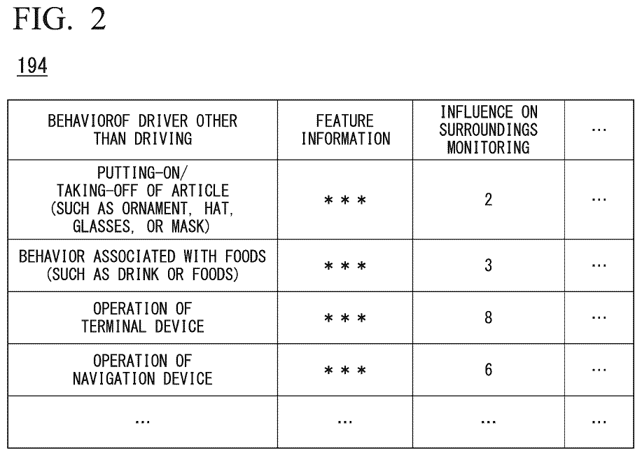

FIG. 2 is a diagram illustrating an example of data details of driver state data 194. The driver state data 194 illustrated in FIG. 2 is, for example, data in which a driver's behavior other than driving, feature information, and a degree of influence on surroundings monitoring are correlated. The driver's behavior other than driving includes, for example, a driver's putting-on/taking-off of an article (for example, an ornament such as an accessory, a hat, glasses, or a mask), a driver's behavior associated with foods, operating of a terminal device such as a smartphone, and operating of the navigation device. The behavior associated with foods may include, for example, a behavior of opening/closing a lid of a drink and a behavior of taking foods out of a bag in addition to behaviors of having a drink or eating foods (which includes chewing gum). The feature information is feature information corresponding to each behavior which is acquired from an image captured by the cabin camera 70. The feature information may include feature information (for example, information on a driver's motion) acquired from images (a video) captured in a time series. The degree of influence on surroundings monitoring is, for example, an index value indicating a degree of decreased concentration on surroundings monitoring and indicates that the concentration on the surroundings monitoring decreases (the driver does not concentrate) as a numerical value thereof increases. The driver state data 194 may be acquired from an external device via the communication device 20 or may be registered in advance by a driver or the like.

The degree of influence on surroundings monitoring may be adjusted for each driver or may be adjusted on the basis of the number of times a behavior other than driving has been taken. For example, regarding the same behavior, some drivers may be able to concentrate on surroundings monitoring or other drivers may not be able to concentrate on surroundings monitoring. Regarding putting-on/taking-off of an article, eating of foods, or the like, when a driver is familiar with such a behavior, the driver can take the behavior in a state in which the degree of influence on surroundings monitoring is small. Accordingly, by adjusting the degree of influence for each driver or decreasing the degree of influence according to the number of execution times, it is possible to more appropriately perform a determination process using the determiner 140 which will be described later.

The recognizer 120 includes, for example, a surrounding recognizer 122, a monitoring direction recognizer 124, a state recognizer 126, and a behavior recognizer 128. The surrounding recognizer 122 recognizes a surrounding situation of the vehicle M, for example, on the basis of the results of detection from a detection device DD (information input from the camera 10, the radar device 12, and the LIDAR device 14). For example, the surrounding recognizer 122 recognizes states such as a position (relative position), a size, a speed (relative speed), and an acceleration of an object near the vehicle M (for example, within a predetermined distance from the vehicle M) by performing a sensor fusion process on the results of detection from some or all of the camera 10, the radar device 12, and the LIDAR device 14. Examples of the object recognized by the surrounding recognizer 122 include a traffic participant (an example of an obstacle) such as another vehicle, a pedestrian, or a bicycle in addition to the physical boundaries defining a road (a traveling lane). For example, a position of an object is recognized as a position in an absolute coordinate system with a representative point (such as the center of gravity or the center of a drive shaft) of the vehicle M as an origin and is used for control. A position of an object may be expressed as a representative point such as the center of gravity or a corner of the object or may be expressed as an area. A “state” of an object may include, for example, an acceleration, a jerk, or a “moving state” (for example, whether another vehicle is performing lane change or whether another vehicle is going to performing lane change) of another vehicle when the object is the other vehicle.

The surrounding recognizer 122 may recognize, for example, a stop line, a red signal, a toll gate, other road events, a road sign, or a marking drawn on a road (for example, a speed limit). The surrounding recognizer 122 may recognize a curvature of a traveling lane (a traveling road) of the vehicle M on the basis of a result of detection from the detection device DD or the map information 192. The surrounding recognizer 122 may recognize road conditions (for example, whether a road surface is frozen and thus slidable) on the basis of the result of detection from the detection device DD.

The surrounding recognizer 122 recognizes, for example, a lane (a traveling lane) in which the vehicle M is traveling or a lane (for example, a neighboring lane) near the traveling lane. For example, the surrounding recognizer 122 recognizes road marking lines from an image captured by the camera 10 and recognizes the traveling lane or other lanes on the basis of a positional relationship of the vehicle M with the recognized road marking lines. The surrounding recognizer 122 may recognize the traveling lane of the vehicle M and other lanes with reference to the map information 192 on the basis of the position information of the vehicle M acquired from the vehicle sensor 40 or the like. The surrounding recognizer 122 may recognize a structure such as a tunnel, an overpass, or a viaduct or a structure near a road.

The monitoring direction recognizer 124 performs a known image analyzing process (for example, a matching process such as extraction of features such as edges, shapes, sizes, and colors or pattern matching) on an image captured by the cabin camera 70 and recognizes a monitoring direction of a driver of the vehicle M on the basis of the image analysis result. For example, the monitoring direction recognizer 124 recognizes the monitoring direction using at least one of a gaze and a face direction of the driver acquired from the image analysis result.

For example, the monitoring direction recognizer 124 detects a combination of a reference point of an eye (a part in which the eye does not move) and a moving point (a part in which the eye moves) of a driver from the captured image using a technique such as pattern matching. The combination of a reference point and a moving point is, for example, a combination of an inner canthus and an iris or a combination of a corneal reflection area and a pupil. The corneal reflection area is, for example, an infrared reflection area in a cornea when the cabin camera 70 irradiates the driver with infrared light. Then, the monitoring direction recognizer 124 recognizes a gaze of the driver by performing coordinate conversion from an image plane to a real space on the basis of the position of the moving point relative to the reference point.

The monitoring direction recognizer 124 recognizes a face direction of the driver on the basis of position information of eyes, a nose, a mouse or the like (relative position information of the regions) in a face area acquired from the analysis result of a captured image.

When both the gaze and the face direction of the driver can be recognized, the monitoring direction recognizer 124 recognizes the monitoring direction using both the gaze and the face direction. Accordingly, it is possible to more accurately recognize the monitoring direction. When only one of the gaze and the face direction is recognized, the monitoring direction recognizer 124 recognizes the monitoring direction using the one.

The monitoring direction recognizer 124 may recognize sunglasses, eyeglasses, or a mask worn by the driver through template matching or the like from the image analysis result of the cabin camera 70. In this case, when the driver wears sunglasses or eyeglasses, the monitoring direction recognizer 124 recognizes the monitoring direction on the basis of only the face direction. When the driver wears a mask, features of a noise, a mouse, or the like are not recognized from the image and recognition accuracy of the face direction decreases, and thus the monitoring direction recognizer 124 recognizes the monitoring direction on the basis of only the gaze.

In the aforementioned recognition of information using an image, for example, a trained model which has been trained in advance through machine learning or the like may be used. In this case, the monitoring direction recognizer 124 inputs an image captured by the cabin camera 70 to the trained model with an image as an input and with a monitoring direction (for example, a gaze or a face direction) of a person included in the image as an output and acquires the monitoring direction of the driver. The monitoring direction recognizer 124 may recognize the monitoring direction using other known methods.

The result of recognition from the monitoring direction recognizer 124 may include information indicating whether the monitoring direction has been recognized on the basis of the gaze of the driver, whether the monitoring direction has been recognized on the basis of the face direction of the driver, or whether the monitoring direction has been recognized on the basis of both. The result of recognition may include information indicating whether the gaze of the driver has been recognized from one eye of the driver or from two eyes of the driver and may include information indicating that a gaze has not been recognized or information indicating that a face direction has not been recognized.

The monitoring direction recognizer 124 may recognize an amount of change in monitoring direction of the driver in a predetermined time or a changing speed of the monitoring direction. The amount of change is, for example, a total amount of change by which the monitoring direction has moved in the predetermined time (for example, a total amount of movement on the left and right sides when the monitoring direction has moved to left and right). The speed may be a maximum speed or an average speed in the predetermined time.

The state recognizer 126 recognizes a driver state. For example, the state recognizer 126 performs a known image analyzing process (for example, feature extraction of edges, shapes, sizes, or colors) on an image captured by the cabin camera 70 and acquires the driver's behavior other than driving corresponding to the feature information in which a degree of match (which may also be replaced with a degree of similarity) is equal to or greater than a predetermined value and which has the highest degree of match and a degree of influence on surrounding monitoring with reference to feature information in the driver state data 194 stored in the storage 190 using feature information acquired as a result of image analysis. The feature information may include feature information (for example, information on a driver's behavior) acquired from images (a video) captured in a time series. For example, the feature information may include feature information based on an object (an article) carried by a driver or a hand's movement, a gaze or face direction of a driver, or the like.

The state recognizer 126 may acquire a behavior other than driving and a degree of influence on surrounding monitoring by inputting the feature information acquired from an image to a trained model with feature information as an input and with a degree of influence of a driver's behavior other than driving on surrounding monitoring as an output. For example, the trained model may be acquired from an external device via the communication device 20 or may be stored in the storage 190.

The behavior recognizer 128 recognizes a behavior of the vehicle M on the basis of the results of detection from the vehicle sensor 40 or control details which are performed by the traveling controller 180. The behavior of the vehicle M includes a behavior based on a driver's manual driving or a behavior based on driving control performed by the traveling controller 180.

For example, the behavior recognizer 128 recognizes a lateral position (a position in a lane width direction) of the vehicle M with respect to the traveling lane or a posture (direction) of the vehicle M with respect to an extending direction of the traveling lane on the basis of the positional relationship between the vehicle M and the traveling lane. For example, the behavior recognizer 128 may recognize a degree of separation of a reference point of the vehicle M from the lane center and an angle of the traveling direction of the vehicle M with respect to a line formed by connecting the lane centers as a relative position and a relative posture of the vehicle M with respect to the traveling lane. Instead, the behavior recognizer 128 may recognize a position of the reference point of the vehicle M with respect to one side line of the traveling lane (a road marking line or a road boundary) or the like as the relative position (a lateral position) of the vehicle M with respect to the traveling lane. The behavior recognizer 128 may recognize a lateral behavior of the vehicle M (for example, whether the vehicle M moves laterally by a predetermined distance or longer) from the lateral position of the vehicle M or an amount of change in direction (yaw rate) of the vehicle M. The behavior recognizer 128 may recognize that the behavior of the vehicle M gets out of order when the amount of change is equal to or greater than a predetermined amount.

The behavior recognizer 128 detects a behavior of the vehicle M or recognizes an amount of change in behavior in a predetermined time on the basis of an amount of operation of the steering wheel (for example, a rudder angle, a steering torque, or a rate of change in steering torque) and an amount of depression of the accelerator pedal or the brake pedal which are acquired by the operation detector while the vehicle M is being driven by manual driving.

The behavior recognizer 128 recognizes the behavior of the vehicle M on the basis of details of driving control which is performed by the traveling controller 180. The driving control is control for controlling at least one of steering and the speed of the vehicle M such that the vehicle M travels regardless of a driving operation from a driver or in response to reception of only a partial operation instruction. The driving control includes, for example, an adaptive cruise control system (ACC), a lane keeping assistance system (LKAS), and an auto lane changing system (ALC). The driving control may include control for stopping the vehicle M at a safe position such as a road shoulder or control for controlling steering or the speed such that the vehicle M avoids collision with an obstacle recognized by the surrounding recognizer 122. For example, the behavior recognizer 128 recognizes a behavior of the vehicle M based on execution of driving control such as LKAS or ALC by the traveling controller 180.

The determiner 140 includes, for example, a first determiner 142 and a second determiner 144. The first determiner 142 determines whether the monitoring direction of the driver is appropriate on the basis of the result of recognition from the monitoring direction recognizer 124.

The second determiner 144 determines whether the driver is taking a behavior other than driving of the vehicle M on the basis of the result of recognition from the state recognizer 126. Details of the functions of the first determiner 142 and the second determiner 144 will be described later.

The HMI controller 160 notifies an occupant (who includes a driver) of predetermined information using the HMI 30 or receives information input by the HMI 30. The predetermined information includes, for example, information associated with traveling of the vehicle M such as information on the state of the vehicle M or information on driving control. The information on the state of the vehicle M includes, for example, a speed, an engine rotation speed, and a shift position of the vehicle M. The information on driving control includes, for example, information indicating whether driving control is to be performed by the traveling controller 180, information on an execution situation of driving control, information on recommendation (proposal) of driving control from a system side, and notification information (such as an alarm) for the driver. The predetermined information may include information on the surrounding situation recognized by the detection device DD. The predetermined information may include information not associated with traveling of the vehicle M such as television programs and content (for example, movies) stored in a storage medium such as a DVD. The predetermined information may include information on a current position or a destination of the vehicle M and a residual amount of fuel of the vehicle M. The HMI controller 160 may output the information received by the HMI 30 to the communication device 20, the navigation device 50, the recognizer 120, the determiner 140, the traveling controller 180, and the like.

The HMI controller 160 may generate inquiry information recommendation information for an occupant, the results of recognition from the recognizer 120, the results of determination from the determiner 140, notification information, and the like and output the generated information to the HMI 30. The generated information includes an image or an audio (which includes an alarm sound). The HMI controller 160 may transmit various types of information which the HMI 30 is caused to output to a terminal device used by the occupant of the vehicle M via the communication device 20.

The traveling controller 180 controls traveling of the vehicle M. For example, the traveling controller 180 performs driving control for the vehicle M on the basis of the results of recognition from the recognizer 120, the results of determination from the determiner 140, or the like. The driving control may be performed in response to an instruction input to the HMI 30 by the driver or may be performed regardless of an instruction from the driver on the basis of the results of recognition from the recognizer 120 or the like. When the driving control is performed, the traveling controller 180 generates a future target trajectory of the vehicle M based on details of the driving control on the basis of the results of recognition from the recognizer 120, information on a destination set by the navigation device 50, the results of detection from the vehicle sensor 40, or the like and controls at least one of the steering and the speed of the vehicle M such that the vehicle M travels along the generated target trajectory.

For example, the traveling controller 180 performs driving control such as ACC, LKAS, or ALC. When the driver's monitoring direction is not improved even if a predetermined time or longer elapses after notification information indicating that the driver's monitoring direction is not appropriate or the like is output by the HMI controller 160 and the driver is taking a behavior other than driving with a high degree of influence on surrounding monitoring in a predetermined time or longer, the traveling controller 180 performs control for stopping the vehicle to at a safe position such as a road shoulder or performs control for avoiding collision between an obstacle and the vehicle M.

The travel driving force output device 200 outputs a travel driving force (a torque) for allowing the vehicle to travel to driving wheels. The travel driving force output device 200 includes, for example, a combination of an internal combustion engine, an electric motor, and a transmission and an electronic control unit (ECU) that controls them. The ECU controls the aforementioned constituents on the basis of information input from the traveling controller 180 or information input from the accelerator pedal of the driving operator 80.

The brake device 210 includes, for example, a brake caliper, a cylinder that transmits a hydraulic pressure to the brake caliper, an electric motor that generates a hydraulic pressure in the cylinder, and an ECU. The ECU controls the electric motor on the basis of the information input from the traveling controller 180 or the information input from the driving operator 80 such that a brake torque based on a braking operation is output to vehicle wheels. The brake device 210 may include a mechanism for transmitting a hydraulic pressure generated by an operation of the brake pedal to the cylinder via a master cylinder as a backup. The brake device 210 is not limited to the above-mentioned configuration, and may be an electronically controlled hydraulic brake device that controls an actuator on the basis of information input from the traveling controller 180 such that the hydraulic pressure of the master cylinder is transmitted to the cylinder.

The steering device 220 includes, for example, a steering ECU and an electric motor. The electric motor changes a direction of turning wheels, for example, by applying a force to a rack-and-pinion mechanism. The steering ECU drives the electric motor on the basis of the information input from the traveling controller 180 or the information input from the steering wheel of the driving operator 80 and changes the direction of the turning wheels.

### Determiner

Details of the function of the determiner 140 (the first determiner 142 and the second determiner 144) will be described below. For example, the first determiner 142 determines whether the driver's monitoring direction is appropriate on the basis of the driver's monitoring direction recognized by the monitoring direction recognizer 124 and a preset monitoring target area.

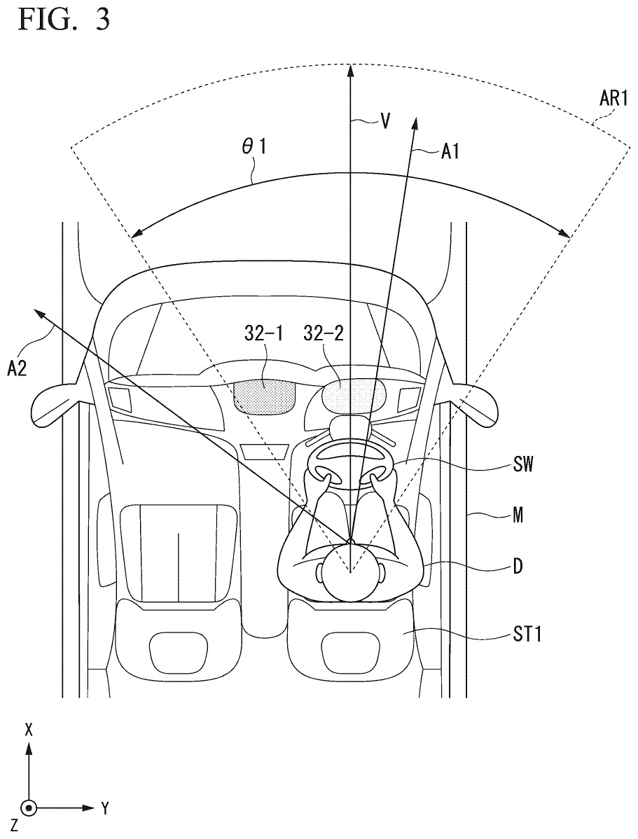

FIG. 3 is a diagram illustrating a relationship between a driver's monitoring direction and a monitoring target area. In the example illustrated in FIG. 3, a situation in which a driver D sits on a driver's seat ST1 of the vehicle M and operates the driving operator 80 such as a steering wheel SW to perform manual driving of the vehicle M is illustrated. In the example illustrated in FIG. 3, displays 32-1 and 32-2 included in the HMI 30 are illustrated.

For example, when the vehicle M is traveling straight ahead (the X-axis direction in the drawing), the first determiner 142 sets a monitoring target area AR1 with
a predetermined angle to right and left with respect to a traveling direction V of the vehicle M from a position of the head of the driver D as illustrated in FIG. 3.

The monitoring target area AR1 may be adjusted according to the speed of the vehicle M or the results of recognition (for example, a road shape or a road width) from the recognizer 120. In this case, for example, the first determiner 142 sets an angle (an arc angle) θ1 indicating the magnitude of an arc of the monitoring target area AR1 to decrease according to the magnitude of the speed or sets the angle θ1 to increase as a road width increases.

The first determiner 142 may adjust the monitoring target area AR1 on the basis of the behavior of the vehicle M recognized by the behavior recognizer 128. For example, the monitoring target area AR1 is rotationally moved to right with respect to the position of the head of the driver D when the behavior recognizer 128 recognizes that the vehicle M is to perform lane change from the traveling lane to a right neighboring lane, and the monitoring target area AR1 is rotationally moved to left with respect to the position of the head of the driver D when the vehicle M is to perform lane change from the traveling lane to a left neighboring lane. In this case, the first determiner 142 may change the magnitude of the angle θ1 in addition to (or instead of) the rotational movement. Even when lane change or a right or left turn is performed by manual driving, the first determiner 142 rotates the monitoring target area AR1 or changes the magnitude of the angle θ1 according to the steering angle or the amount of steering of the vehicle M or the like. When an obstacle (for example, an obstacle on a road) near the vehicle M is recognized by the surrounding recognizer 122, the first determiner 142 may change the magnitude of the angle θ1 to include the obstacle.

For example, in the situation illustrated in FIG. 3, when the monitoring direction of the driver D recognized by the monitoring direction recognizer 124 is included in the angle θ1 of the monitoring target area AR1 (or when the state in which the monitoring direction is included in the angle θ1 is maintained in a predetermined time or longer), the first determiner 142 determines that the monitoring direction of the driver D is appropriate. When the monitoring direction is not included in the angle θ1 (or when the state in which the monitoring direction is not included in the angle θ1 is maintained in a predetermined time or longer), the first determiner 142 determines that the monitoring direction of the driver D is not appropriate. In the example illustrated in FIG. 3, the first determiner 142 determines that the monitoring direction of the driver D is appropriate when the monitoring direction of the driver D is an arrow A1 and determines that the monitoring direction of the driver D is not appropriate when the monitoring direction of the driver D is an arrow A2.

The first determiner 142 may determine whether the driver D is glancing sideways instead of (or in addition to) determining whether the monitoring direction of the driver D is appropriate. In this case, in the situation of the monitoring target area AR1 illustrated in FIG. 3, the first determiner 142 determines that the driver D is not glancing sideways when the monitoring direction of the driver D is the arrow A1 and determines that the driver D is glancing sideways when the monitoring direction of the driver D is the arrow A2.

When a behavior other than driving has been acquired using the driver state data 194 or the trained model from the feature information of an image captured by the cabin camera 70, the second determiner 144 determines that the driver D is taking a behavior other than driving of the vehicle M on the basis of the results of recognition from the state recognizer 126. When a behavior other than driving has not been acquired, the second determiner 144 determines that the driver D is not taking a behavior other than driving of the vehicle M.

The second determiner 144 may determine whether the behavior other than driving is a behavior with a low degree of influence on surroundings monitoring on the basis of the degree of influence on surroundings monitoring correlated with the behavior other than driving recognized by the state recognizer 126. For example, the second determiner 144 determines that that behavior is a behavior with a low degree of influence on surroundings monitoring when the degree of influence is less than a threshold value (a first threshold value) and determines that that behavior is not a behavior with a low degree of influence on surroundings monitoring when the degree of influence is equal to or greater than the first threshold value. The determination process performed by the second determiner 144 may be performed only when the first determiner 142 determines that the monitoring direction of the driver D is appropriate. Accordingly, it is possible to reduce a load of the determination process.

### Notification Control

Details of notification control according to the embodiment will be described below. The HMI controller 160 controls notification for the driver D according to the results of determination from the first determiner 142 and the second determiner 144. For example, when the first determiner 142 determines that the monitoring direction of the driver D is not appropriate as an example of a notification condition, the HMI controller 160 generates notification information on a sideways glance (first notification information) regardless of the result of determination from the second determiner 144 and causes the HMI 30 to output the generated first notification information and to notify the driver D. The first notification information may be information indicating that the monitoring direction of the driver D is not appropriate (or that the driver D is glancing sideways) or information for prompting the driver D to face a correct monitoring direction. The first notification information may include, for example, an image indicating the monitoring direction of the driver D as illustrated in FIG. 3 or an image including the monitoring target area AR1. Accordingly, it is possible to more accurately allow the driver D to ascertain that the monitoring direction is not appropriate or the monitoring direction. The first notification information may be an image, an audio (for example, a predetermined alarm sound), or both thereof. In this way, when the monitoring direction of the driver D is not appropriate, it is possible to more appropriately notify the driver by reliably notifying the driver that the monitoring direction of the driver D is not appropriate with priority in the aspect of safety.

When the first determiner 142 determines that the monitoring direction of the driver D is appropriate and the second determiner 144 determines that the driver D is taking a behavior other than driving of the vehicle M, the HMI controller 160 may generate notification information on surroundings monitoring (second notification information) and cause the HMI 30 to output the generated second notification information and to notify the driver D. The second notification information may be information indicating that there is a likelihood that the driver is not satisfactorily performing surroundings monitoring due to a behavior other than driving or information for prompting the driver to stop the behavior other than driving. The second notification information may include information on the behavior other than driving recognized from an image captured by the cabin camera 70. The second notification information may be an image, an audio (for example, a predetermined alarm sound), or both thereof. By notifying of the second notification information, it is possible to notify the driver D, for example, that the driver D needs to concentrate on the surroundings monitoring. The HMI controller 160 may notify of the first notification information on a sideways glance instead of the second notification information.

When the first determiner 142 determines that the monitoring direction of the driver D is appropriate, the second determiner 144 determines that the driver D is taking a behavior other than driving of the vehicle M, and the behavior other than driving is a behavior of which the degree of influence on surroundings monitoring is less than the first threshold value (for example, less than 5), the HMI controller 160 curbs notification of the second notification information. Curbing of the notification may mean that the notification is not performed, that one of an image and an audio is output when the second notification information includes an image and an audio, or that a sound volume is decreased or a display time of an image is decreased. Accordingly, it is possible to curb excessive notification of a behavior with a low degree of influence on surroundings monitoring.

The first threshold value may be a fixed value or may be adjusted for each driver D. The first threshold value may be adjusted according to a surrounding situation of the vehicle M. For example, the first threshold value is set to be greater than a reference value when the traveling direction of the vehicle M is straight and there is no object such as another vehicle near the vehicle M, and the first threshold value is set to be less than the reference value when the traveling direction of the vehicle M is not straight such as curved or when there is an object such as another vehicle near the vehicle M. Accordingly, it is possible to perform more appropriate notification of each driver according to a surrounding situation.

The behavior of which the degree of influence on surroundings monitoring is less than the first threshold value may be, for example, a behavior (a first behavior) which is predicted to end within a predetermined time. Since a behavior to end in a short time affects the surroundings monitoring less, it is possible to curb excessive notification of the driver D and to perform more appropriate notification by curbing notification for the first behavior.

The behavior of which the degree of influence on surroundings monitoring is less than the first threshold value may include, for example, a behavior (a second behavior) which is predicted to be performed by the driver D with one hand in addition to (or instead of) the first behavior. For example, when the driver grasps an object (for example, a drink or foods) to take a behavior other than driving with one hand, the driver D grasps the steering wheel SW with the other hand. Accordingly, since appropriate driving is possible even when surroundings monitoring is temporarily neglectful, it is possible to curb excessive notification of the driver D and to perform more appropriate notification by curbing notification in this situation.

The behavior of which the degree of influence on surroundings monitoring is less than the first threshold value may be, for example, a behavior (a third behavior) which is predicted to be performed by the driver D without seeing that behavior in addition (or instead of) the first behavior or the second behavior. For example, when the driver removes an ornament such as an accessory or a mask worn by the driver, the driver can take that behavior without seeing the behavior. Accordingly, in the third behavior, since the gaze of the driver D can be held in the monitoring target area AR1, it is possible to curb excessive notification of the driver D and to perform more appropriate notification by curbing notification for the third behavior.

The behavior of which the degree of influence on surroundings monitoring is less than the first threshold value may be a behavior with which the driver D puts on or takes off a wearing article or a behavior of the driver D associated with foods. In this case, regarding these two behaviors, the degree of influence on surroundings monitoring included in the driver state data 194 may be adjusted to be less than the first threshold value. In this way, it is possible to curb excessive notification by curbing notification when the driver puts on or takes off an ornament which can be simply put on or taken off or eats simple foods such as drinks or gum.

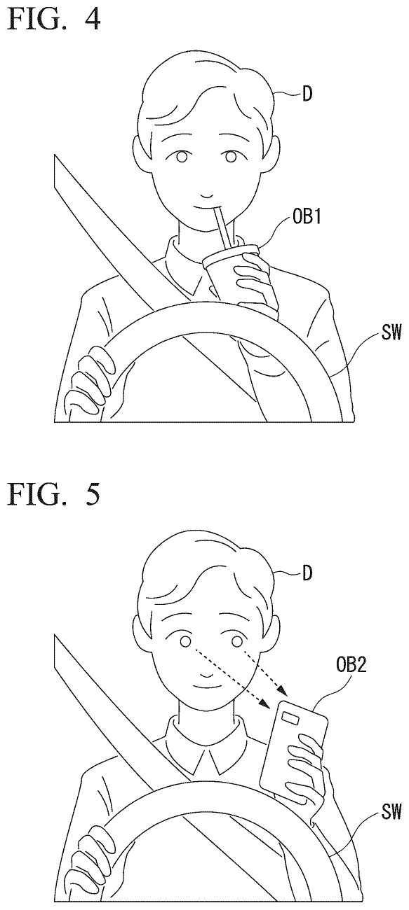

FIG. 4 is a diagram illustrating an example of a situation in which notification of the second notification information is curbed. In the example illustrated in FIG. 4, an image of a driver D included in the image captured by the cabin camera 70 is illustrated. In the example illustrated in FIG. 4, the driver D grasps the steering wheel SW with one hand and grasps an object (an article) OB1 such as a drink case with the other hand. In this situation, the driver D does not need to continuously see the object OB1 and can take a behavior other than driving while maintaining the monitoring direction inside of the monitoring target area AR1. In this way, a behavior of having a drink is predicted to end in several seconds. Accordingly, in this situation, the HMI controller 160 can curb notification of the second notification information, and thus it is possible to curb excessive notification.

FIG. 5 is a diagram illustrating an example of a situation in which notification of the second notification information is not curbed. The example illustrated in FIG. 5 is different from the example illustrated in FIG. 4, in that the driver grasps an object (a terminal device) OB2 such as a smartphone with which content such as a video can be seen instead of the object OB1 such as a drink case. In this situation, the gaze of the driver D is likely to continuously see the screen of the object OB2 and does not maintain the monitoring direction inside of the monitoring target area AR1. The behavior of seeing content or the like is predicted to be maintained in a long time. Accordingly, in this situation, the HMI controller 160 does not notify of the second notification information (does not curb notification), and thus it is possible to more appropriately notify the driver D.

When an amount of change or a changing speed of the monitoring direction of the driver D recognized by the state recognizer 126 in a predetermined time is equal to or greater than a threshold value (a second threshold value), the HMI controller 160 may perform notification regardless of the result of determination from the first determiner 142 and the result of determination from the second determiner 144. Performing notification regardless of the result of determination from the first determiner 142 and the result of determination from the second determiner 144 includes, for example, performing notification when the first determiner 142 determines that the monitoring direction of the driver D is appropriate, the second determiner 144 determines that the driver D has not taken a behavior other than driving of the vehicle M, or it is determined that the behavior other than driving is taken but the degree of influence on surroundings monitoring is less than the first threshold value.

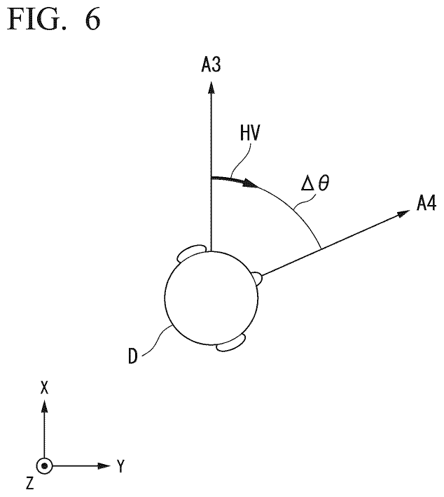

FIG. 6 is a diagram illustrating a change in monitoring direction of a driver D. In the example illustrated in FIG. 6, the monitoring direction of the driver D changes from A3 to A4 in a predetermined time. The HMI controller 160 performs notification when the amount of change (an amount of angle change in FIG. 6) Δθ in a predetermined time is equal to or greater than the second threshold value corresponding to the amount of change or a changing speed HV of the monitoring direction is equal to or greater than the second threshold value corresponding to the speed. The monitoring directions A3 and A4 at that time may be inside of the monitoring target area AR1 or outside of the monitoring target area AR1. Accordingly, even when the monitoring direction is appropriate, the amount of movement Δθ or the changing speed HV of the monitoring direction is large, and it is predicted that the driver will not pay attention to surroundings monitoring, it is possible to reliably perform notification with priority in the aspect of safety. The amount of movement Δθ or the changing speed HV of the monitoring direction illustrated in FIG. 6 indicate an amount of movement and a speed in the horizontal direction (on the XY plane), but may be an amount of movement and a speed in a three-dimensional space (XYZ axes) in the embodiment.

The second threshold value may be changed according to the situation of the vehicle M (for example, lane change, left or right turn, or collision avoidance) or the like. For example, when lane change, left or right turn, or collision avoidance is performed by driving control using the traveling controller 180 or manual driving of the driver D, it is necessary to monitor the surroundings in addition to the traveling direction of the vehicle M, and thus the amount of change or the changing speed of the monitoring direction of the driver D becomes greater than those in the normal state. Accordingly, by setting the second threshold value to be greater than that in the normal state in the aforementioned traveling situation of the vehicle, it is possible to curb unnecessary notification for a sideways glance or surroundings monitoring in the case of lane change, left or right turn, or collision avoidance.

When the first determiner 142 determines that the monitoring direction of the driver D is not appropriate and the second determiner 144 determines that the driver D is taking a behavior other than driving of the vehicle M, the HMI controller 160 may output both the first notification information and the second notification information or output the notification information of which a preset priority is higher. When the first determiner 142 determines that the monitoring direction of the driver D is appropriate and the second determiner 144 determines that the driver D is not taking a behavior other than driving of the vehicle M, the HMI controller 160 ends the notification.

### Process Flow

A process flow that is performed by the driving support device 100 according to the embodiment will be described below. In the following description, a notification process based on a monitoring direction or a behavior of a driver D out of processes performed by the driving support device 100 will be mainly described.

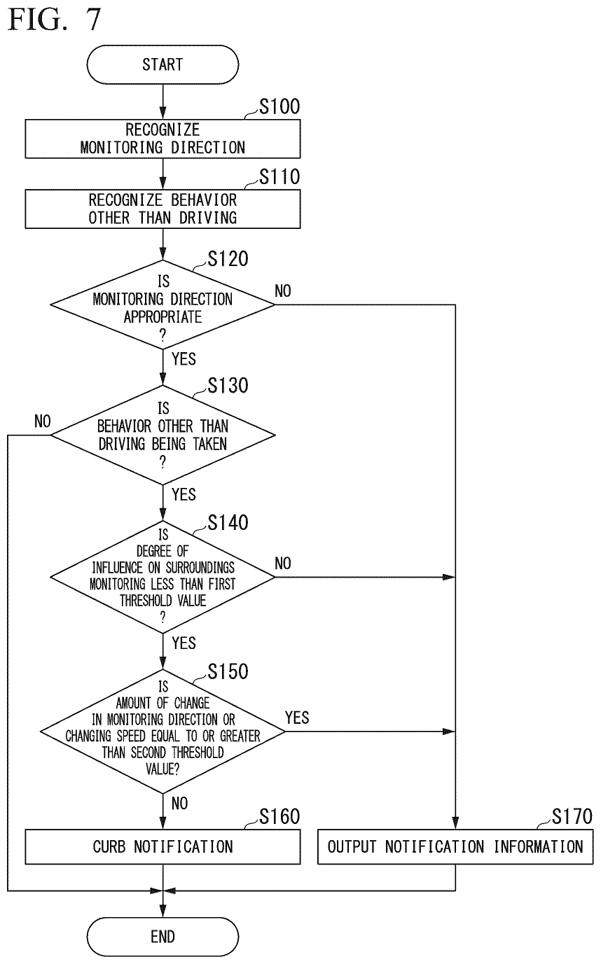

FIG. 7 is a flowchart illustrating an example of a process flow that is performed by the driving support device 100 according to the embodiment. In the example illustrated in FIG. 7, the monitoring direction recognizer 124 recognizes a monitoring direction of the driver D of the vehicle M (Step S100). Then, the state recognizer 126 recognizes a behavior of the driver D other than driving (Step S110). Then, the first determiner 142 determines whether the monitoring direction of the driver D is an appropriate monitoring direction (Step S120). When it is determined that the monitoring direction is appropriate, the second determiner 144 determines whether the driver D is taking a behavior other than driving (Step S130).

When it is determined that the driver D is taking a behavior other than driving, the second determiner 144 determines whether an influence on surroundings monitoring is less than a first threshold value (Step S140). When it is determined that the influence on surroundings monitoring is less than the first threshold value, the HMI controller 160 determines whether an amount of change or a changing speed of the monitoring direction is equal to or greater than a second threshold value (Step S150). When it is determined that the amount of change or the changing speed of the monitoring direction is not equal to or greater than the second threshold value (less than the second threshold value), the HMI controller 160 curbs notification to the driver D (Step S160).

When it is determined in Step S120 that the monitoring direction is not appropriate, when it is determined in Step S140 that the influence on the surroundings monitoring is not less than the first threshold value (equal to or greater than the first threshold value), or when it is determined in Step S150 that the amount of change or the changing speed of the monitoring direction is equal to or greater than the second threshold value, the HMI controller 160 generates corresponding notification information (for example, the first notification information or the second notification information) and notifies the driver D of the notification information by causing the HMI 30 to output the notification information. As a result, this process flow of the flowchart ends. When it is determined in Step S130 that the driver D is not taking a behavior other than driving, this process flow of the flowchart ends (Step S170).

### Modified Examples

In the embodiment, the HMI controller 160 may generate information on a behavior of the driver D other than driving recognized by the state recognizer 126 and cause the HMI 30 to output the generated information. The HMI controller 160 may generate information for inquiring of the driver D about whether the recognized behavior other than driving is correct, cause the HMI 30 to output the generated information, and update information of the driver state data 194 or the like on the basis of a result of inquiry (a response from the driver D). Accordingly, it is possible to more accurately recognize a state for each driver D.

When the notification is curbed in a situation in which the monitoring direction of the driver D is included in the monitoring target area AR1 and the monitoring direction of the driver D moves to the outside of the monitoring target area AR1, the HMI controller 160 may release the curbing and perform notification. Accordingly, it is possible to immediately validate (restore) notification control.

In the embodiment, when the first determiner 142 determines that the monitoring direction of the driver D is appropriate while performing driving control, the second determiner 144 determines that the driver D is taking a behavior other than driving, and the behavior other than driving is a behavior of which the degree of influence on surroundings monitoring is less than the first threshold value, the traveling controller 180 continues to perform the driving control. Accordingly, since the driving control can continue to be performed for a behavior other than driving of which the degree of influence on surroundings monitoring is small, it is possible to realize stable traveling control by curbing change of the control.

When the first determiner 142 determines that the monitoring direction of the driver D is not appropriate (or when it is determined that this state is maintained in a predetermined time or longer) while performing driving control, the traveling controller 180 ends the driving control. When the second determiner 144 determines that the driver D is taking a behavior other than driving of the vehicle M while performing driving control and the behavior other than driving is a behavior of which the degree of influence on surroundings monitoring is equal to or greater than the first threshold value (or when this state is maintained in a predetermined time or longer), the traveling controller 180 may end the driving control. In this case, the HMI controller 160 may cause the HMI 30 to output information indicating that the driving control under execution ends along with the first notification information or the second notification information and to notify the driver D.

According to the aforementioned embodiment, the notification control device includes the recognizer 120 configured to recognize a monitoring direction of a driver of a vehicle M (an example of a mobile object) and a state of the driver, the first determiner 142 configured to determine whether the monitoring direction of the driver is appropriate on the basis of a result of recognition from the recognizer 120, the second determiner 144 configured to determine whether the driver is taking a behavior other than driving of the vehicle M on the basis of the result of recognition, and the notification controller (the HMI 30 and the HMI controller 160) configured to control notification to the driver D on the basis of a result of determination from the first determiner 142 and a result of determination from the second determiner 144. The notification controller curbs the notification when is the first determiner 142 determines that the monitoring direction of the driver is appropriate, is the second determiner 144 determines that the driver is taking a behavior other than driving, and a degree of influence of the behavior other than driving on surroundings monitoring is less than a first threshold value. Accordingly, it is possible to perform more appropriate notification according to the state of the driver.

For example, according to the embodiment, by not performing notification when the driver is taking a behavior (an operation) other than driving as the driver's behavior, the monitoring direction is appropriate, and the behavior other than driving is a behavior of which an influence on surroundings monitoring is small, it is possible to curb excessive notification and thus to perform more appropriate notification according to the state of the driver.

According to the embodiment, it is possible to curb excessive notification by curbing notification when a driver takes a behavior in a short time or a behavior which can be taken with one hand (for example, putting-on/taking-off of an ornament or eating of foods). According to the embodiment, by performing notification when it is determined that the monitoring direction is not appropriate or the amount of change or the changing speed of the monitoring direction is equal to or greater than the second threshold value, it is possible to perform more appropriate notification.

The above-mentioned embodiment can be expressed as follows:

A notification control device including:
a storage medium storing computer-readable instructions; and
a processor connected to the storage medium,
wherein the processor executes the computer-readable instructions to perform:
   recognizing a monitoring direction of a driver of a mobile object and a state of the driver;
   determining whether the monitoring direction of the driver is appropriate on the basis of a result of recognition;
   determining whether the driver is taking a behavior other than driving of the mobile object on the basis of the result of recognition;
   controlling notification to the driver on the basis of results of determination; and
   curbing the notification when it is determined that the monitoring direction of the driver is appropriate, it is determined that the driver is taking a behavior other than driving, and a degree of influence of the behavior other than driving on surroundings monitoring is less than a first threshold value.

While exemplary embodiments of the present invention have been described above, the present invention is not limited to the embodiments and can have various modifications and substitutions applied thereto without departing from the gist of the present invention.

What is claimed is:

1. A notification control device comprising:
a recognizer configured to recognize a monitoring direction of a driver of a mobile object and a state of the driver;
a first determiner configured to determine whether the monitoring direction of the driver is appropriate on the basis of a result of recognition from the recognizer;
a second determiner configured to determine whether the driver is taking a behavior other than driving of the mobile object on the basis of the result of recognition; and
a notification controller configured to control notification to the driver on the basis of a result of determination from the first determiner and a result of determination from the second determiner,
wherein the notification controller curbs the notification when the first determiner determines that the monitoring direction of the driver is appropriate, the second determiner determines that the driver is taking a behavior other than driving, and a degree of influence of the behavior other than driving on surroundings monitoring is less than a first threshold value.

2. The notification control device according to claim 1, wherein the behavior of which the degree of influence on the surroundings monitoring is less than the first threshold value includes a behavior which is predicted to end within a predetermined time.

3. The notification control device according to claim 1, wherein the behavior of which the degree of influence on the surroundings monitoring is less than the first threshold value includes a behavior which is predicted to be taken by the driver with one hand.

4. The notification control device according to claim 1, wherein the behavior of which the degree of influence on the surroundings monitoring is less than the first threshold value includes a behavior in which the driver puts on or takes off a wearing article.

5. The notification control device according to claim 1, wherein the behavior of which the degree of influence on the surroundings monitoring is less than the first threshold value includes a behavior of the driver associated with foods.

6. The notification control device according to claim 1, wherein the notification controller performs the notification regardless of the result of determination from the second determiner when the first determiner determines that the monitoring direction of the driver is not appropriate.

7. The notification control device according to claim 1, wherein the recognizer recognizes an amount of change in monitoring direction of the driver in a predetermined time or a changing speed, and
wherein the notification controller performs notification regardless of the result of determination from the first determiner and the result of determination from the second determiner when the amount of change or the changing speed is equal to or greater than a second threshold value.

8. A notification control method that is performed by a computer, the notification control method comprising:
recognizing a monitoring direction of a driver of a mobile object and a state of the driver;
determining whether the monitoring direction of the driver is appropriate on the basis of a result of recognition;
determining whether the driver is taking a behavior other than driving of the mobile object on the basis of the result of recognition;
controlling notification to the driver on the basis of results of determination; and
curbing the notification when it is determined that the monitoring direction of the driver is appropriate, it is determined that the driver is taking a behavior other than driving, and a degree of influence of the behavior other than driving on surroundings monitoring is less than a first threshold value.

9. A non-transitory computer-readable storage medium storing a program, the program causing a computer to perform:
recognizing a monitoring direction of a driver of a mobile object and a state of the driver;
determining whether the monitoring direction of the driver is appropriate on the basis of a result of recognition;
determining whether the driver is taking a behavior other than driving of the mobile object on the basis of the result of recognition;
controlling notification to the driver on the basis of results of determination; and
curbing the notification when it is determined that the monitoring direction of the driver is appropriate, it is determined that the driver is taking a behavior other than driving, and a degree of influence of the behavior other than driving on surroundings monitoring is less than a first threshold value.
